(19) United States
(12) Patent Application Publication
(10) Pub. No.: US 2012/0099112 A1
(43) Pub. Date: Apr. 26, 2012

(54) Multi-core low reflection lateral output fiber probe

(76) Inventors: Gerard Argant Alphonse, Princeton, NJ (US); Donald Barry Carlin, Pennington, NJ (US)

(21) Appl. No.: 13/317,596

(22) Filed: Oct. 24, 2011

Related U.S. Application Data
(60) Provisional application No. 61/455,630, filed on Oct. 25, 2010.

(51) Int. Cl. G01B 9/02; G02B 17/00; G02B 6/00

(52) U.S. Cl. 356/479; 385/12; 427/163.2

(57) ABSTRACT

Multi-core optical fiber probe includes a multi-core optical fiber (and method of manufacturing the probe) including a plurality of cores adjacent a cladding material, and a plurality of angled reflectors disposed at a distal end of the cores. An angled reflector of the plurality of angled reflectors deflects light propagating in the core at a deflection angle that is different from an axis of light propagation in the core. Light propagating toward a distal end of the core of the multi-core probe is emitted, after reflection by the corresponding reflector, out of the multi-core optical fiber probe.

### CROSS-REFERENCE TO RELATED APPLICATIONS

The present Application is related to and claims priority from co-pending provisional application 61/455,630, filed on Oct. 25, 2010, and incorporated herein by reference.

### BACKGROUND OF THE INVENTION

1. Field of the Invention

The present invention generally relates to an optical fiber probe made of a multi-core optical fiber.

2. Description of the Related Art

In medical diagnostics, there is a need to detect and characterize disease in blood vessels, the esophagus, the pulmonary, gastro-intestinal, and urinary systems and any other hollow anatomical volume accessible either naturally or via surgical methods.

For example, in the detection and treatment of coronary artery disease, plaques, lesions and other vascular pathologies provide information to enable cardiologists to provide adequate therapy. Vulnerable plaques are a specific type of plaque that grows inside the artery and traps lipid within the arterial wall. Due to a natural defense mechanism in the body, such as the effect of macrophage, the thickness of the plaque can be eroded, and when it erodes down to about 65 microns or less, it is prone to rupture. This rupture releases the lipid into the blood stream and may cause a thrombosis. Vulnerable plaque is a leading cause of death by sudden cardiac arrest.

The resolution of state of the art technologies, such as Magnetic Resonance Imaging (MRI) and intravascular ultrasound (IVUS), is limited to about 150 microns and does not enable measurements down to the critical thickness.

An optical interferometric technique known as LCI (Low Coherence Interferometry) provides axial resolution capabilities approximately equal to the coherence length (which is about 10-20 microns with present-day superluminescent diode broadband sources), and therefore is suitable for the detection of vulnerable plaques. One way to construct an LCI instrument is to design an all-fiber interferometer and use the probing fiber component as part of a catheter. However, since the light in the fiber propagates along the fiber axis, some means is required to deflect the probing light toward the arterial wall.

It is also desirable to probe multiple points around the circumference of an artery at the same time. By probing multiple points at the same time and pulling back the fiber along the length of the artery, one can examine a length of several centimeters of artery in a short period of time.

FIGS. 1a and 1b illustrate two configurations 1 for six fibers inside a one-French (i.e., one “French” is equal to approximately 0.33 mm and is used for referencing the size of a catheter) guide wire 12 suitable for probing coronary arteries. The guide wire 12 is a flexible hollow tube commonly used in interventional cardiac procedures, and has an inner diameter of less than about 0.31 mm and an outside diameter of about 0.35 mm. Commercial SM (Single-Mode) fibers are commercially available (from Corning Inc. and other manufacturers) in 125-micron clad diameter and in about 80-micron clad diameter.

Thus, the inner diameter of the guide wire 12 is too small to accommodate six 125-microns diameter fibers, but it may accommodate six fibers 10 of diameter 80-microns or less. Therefore, while one may work with a smaller number of fibers or a guide wire larger than one-French, an embodiment described uses six individual SM fibers having an 80-micron clad diameter. FIG. 1a illustrates a configuration with six fibers 10 around a center wire 16. FIG. 1b illustrates a configuration with a hollow central area 18 formed by the internal circumference of the six fibers 10.

Light propagated through the optical fibers may be deflected out of the guidewire as illustrated by the arrows 14. One manner in which to deflect the light by, for example, 90°, is to grind and polish the fiber tip at 45° and then coat the angled surface with a mirror. However, the resulting transmission through the cylindrical surface of the fiber clad introduces astigmatism in the beam profile. For example, the cylindrical surface transforms the beam from a Gaussian shape with a circular cross section in the fiber to one with an elliptical cross-section. This causes the beam to spread out in one direction and reduces the backscattered light from the targeted direction, thereby reducing the LCI signal by, for example, about 10 dB or more. Without the astigmatism, the LCI signal is some six orders of magnitude below the incident light from the fiber. This loss is not acceptable.

The amount of reflection from the exit plane that is guided back to the detection system is also an important issue. With a high-power light source, it should be reduced as much as possible, preferably less than about −65 dB below the probing light level, in order to keep RIN (Relative Intensity Noise) below the optical shot noise.

### SUMMARY OF THE INVENTION

The use of a plurality of single optical fibers, however, limits the number of optical probes of this kind that may be distributed within the circumference of a probe housing due to the relatively large thickness of the cladding layer of the single optical fibers. For example, in the case of a one-French diameter housing for coronary guidewires, the inner lumen of a hollow tube used to form the guidewire may only be approximately 250 microns in diameter. To accommodate even six fibers, as depicted in FIGS. 1a and 1b, special fibers having an outer diameter of no more than approximately 80 microns must be fabricated and assembled. The assembly and alignment of such multiple fiber probes can be challenging.

Therefore, there is a need for an improvement in the use of multiple single-fibers to form an optical probe suitable for examining the interior of a lumen.

In view of the foregoing, and other, exemplary problems, drawbacks, and disadvantages of the conventional systems, it is an exemplary feature of the present invention to provide a structure in which multiple fibers (or a multiple channel fiber) are accommodated and fabrication is improved.

It is, therefore, an exemplary feature of the present invention to provide a structure and method for a multi-core fiber probe.

In a first exemplary aspect of the present invention, to achieve the above and other features, a multi-core optical fiber probe includes a multi-core optical fiber including a plurality of cores embedded in a cladding material, and a plurality of angled reflectors disposed at a distal end of the cores. An angled reflector of the plurality of angled reflectors deflects light propagating in the core at a deflection angle that is substantially different from the axis of light propagation in the core. Light propagating toward the distal end of the core of the multi-core probe is emitted, after reflection by the corresponding reflector, out of the multi-core optical fiber probe.

In another exemplary aspect of the invention, a method of manufacturing a multi-core optical probe includes providing a multi-core optical fiber including a plurality of cores embedded in a cladding material, and disposing a plurality of angled reflectors disposed at a distal end of the cores. An angled reflector of the plurality of angled reflectors deflects light propagating in the core at a deflection angle that is substantially different from the axis of light propagation in the core. Light propagating toward the distal end of the core of the multi-core probe is emitted, after reflection by the corresponding reflector, out of the multi-core optical fiber probe.

### BRIEF DESCRIPTION OF THE DRAWINGS

The foregoing and other purposes, aspects and advantages will be better understood from the following detailed description of exemplary embodiments of the invention with reference to the drawings, in which:

FIGS. 1a and 1b show a related art arrangement;

FIG. 2a shows a cross-section of an exemplary multi-core fiber;

FIG. 2b shows a cross-section of an exemplary multi-core fiber having a hollow center;

FIGS. 3a and 3b show a side view of exemplary multi-core fibers, with and without a hollow center, respectively;

FIGS. 4a and 4b show exemplary ends of the multi-core fiber having a tilt angle;

FIG. 5 shows a graph showing an exemplary determination of a tilt angle;

FIG. 6 shows an exemplary connector;

FIG. 7 shows an exemplary connector including a locking portion;

FIGS. 8a and 8b show an exemplary embodiment of a guidewire;

FIGS. 9a and 9b show another exemplary embodiment of a guidewire;

FIGS. 10a and 10b show yet another exemplary embodiment of a guidewire;

FIGS. 11a and 11b show another exemplary embodiment of a guidewire having a reflector member;

FIGS. 12a and 12b show yet another exemplary embodiment of a guidewire having a reflector member;

FIGS. 13a and 13b show another exemplary embodiment of a guidewire having a reflector member;

FIGS. 14a and 14b show another exemplary embodiment of a guidewire having a reflector member;

FIG. 15 shows an exemplary embodiment of an interferometric system;

FIG. 16 shows another exemplary embodiment of the interferometric system; and

FIG. 17 shows yet another exemplary embodiment of the interferometric system.

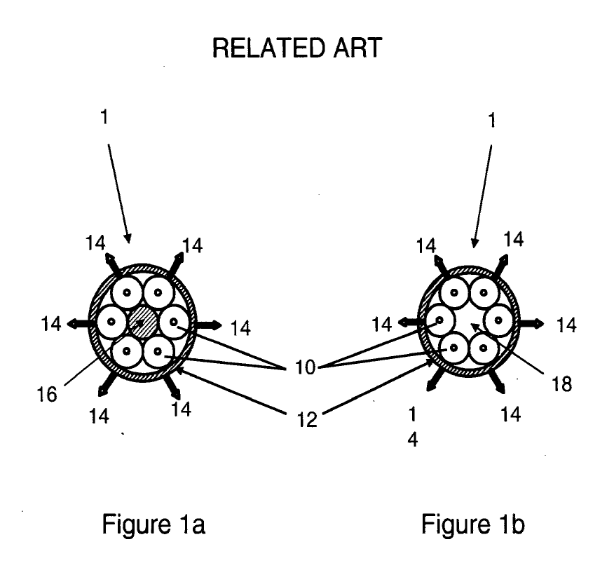

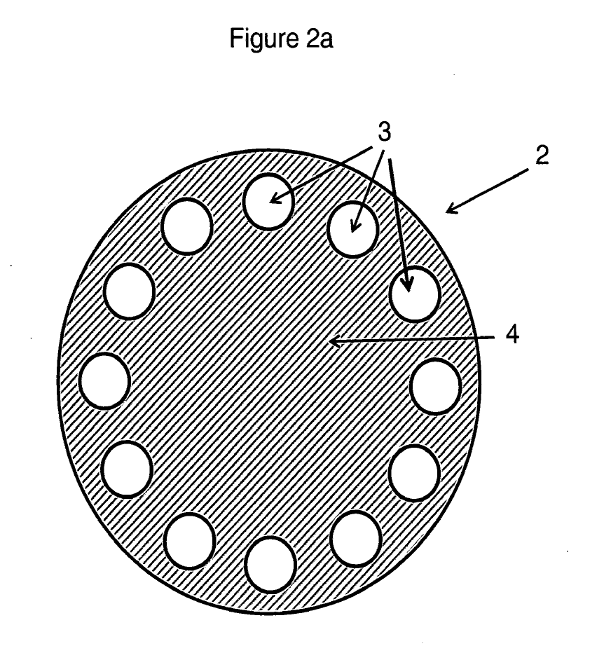

### DETAILED DESCRIPTION OF EXEMPLARY EMBODIMENTS OF THE INVENTION

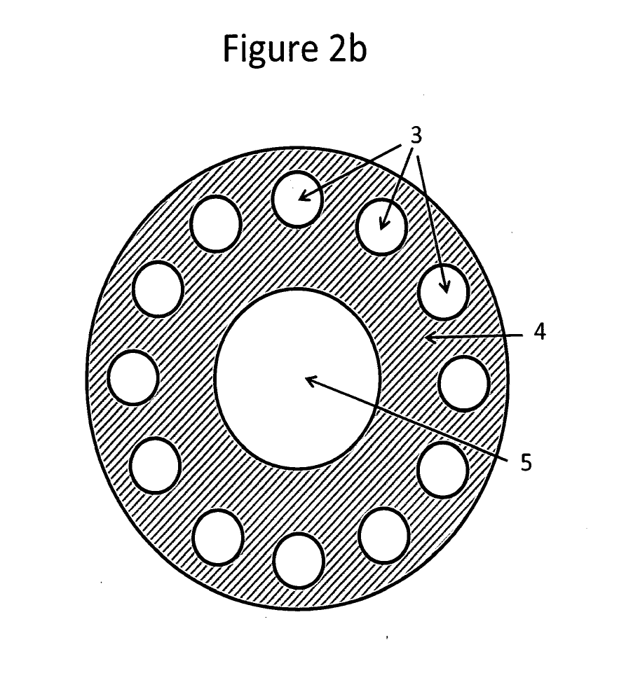

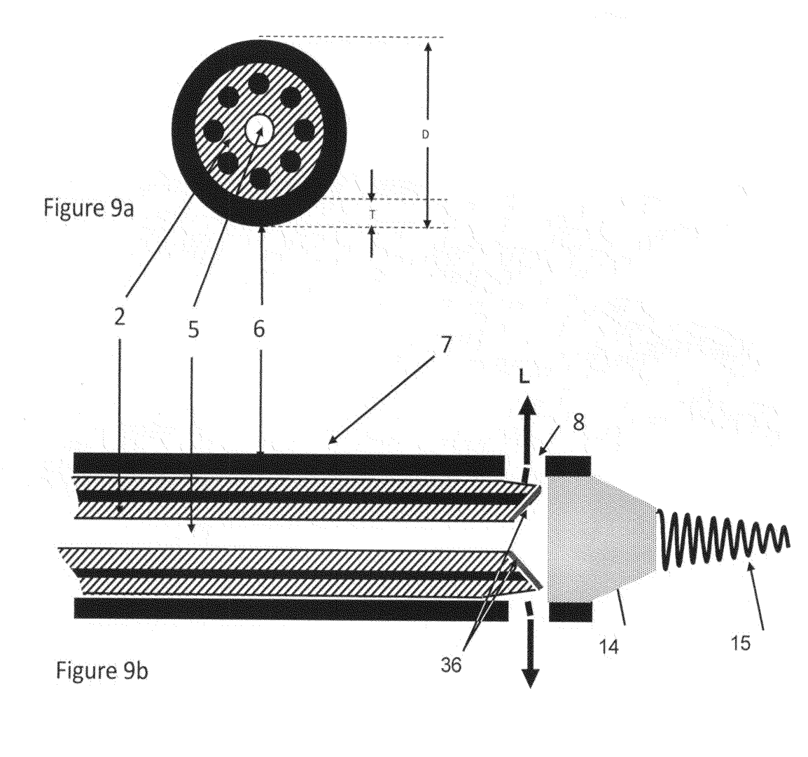

Referring now to the drawings, and more particularly to FIGS. 2-17, there are shown exemplary embodiments of the method and structures according to the present invention.

The invention described herein is directed to an optical probe including a multi-core optical fiber in which each of the cores and surrounding cladding act as a reduced reflection, lateral output optical probe.

Exemplary embodiments of the invention generally relate to a multi-core fiber probe, a system, and a method for minimizing reflection and preventing astigmatism in a fiber probe for use, for example, in a multiple-probe interferometer system. In particular, the exemplary embodiments of the invention relate to a multi-core fiber probe, system and method for minimizing reflection and preventing astigmatism in an optical emitting fiber.

As used herein, “optical emitting fibers” refer to optical fibers that are typically made of glass or a material having a higher dielectric constant than the surrounding medium. An optical emitting fiber generally has a core and a cladding.

The core is a part of the optical fiber through which light is guided, and the choice of core size depends on the wavelength and numerical aperture (NA), and on whether the fiber is intended to propagate light to have a single waveguide mode or multiple waveguide modes. Typically, a single-mode fiber core sized for wavelengths in the visible and near infra-red range may be about 5 to about 9 microns in diameter.

Cladding is a material having a lower refractive index than the core material and may surround the core to both ensure light guiding and may also add mechanical strength to the fiber.

The core and cladding of an optical fiber may be composed of any material through which light may pass including, but not be limited to glass, polymers, plastics, and combinations thereof.

In various exemplary embodiments, the wave propagation in the fiber may be single-mode or multimode. Hence, the term “optical emitting fibers” is also intended to include single-mode or multi-mode fibers. Single-mode fibers may be preferable for most applications, particularly those involving interferometry.

As in the case of a single optical fiber probe, a mirror may, generally, be formed at an end of the optical emitting fibers adjacent to “tilted flats”, and may be formed at an angle of about 45° as measured from a planar surface perpendicularly intersecting an axial centerline of the optical emitting fiber.

The tilted flat may, generally, be formed by removing the cladding around an exit plane or direction of light deflected by the mirror to provide a flat surface through which the deflected light may exit the optical emitting fiber. In exemplary embodiments, the tilted flat may have an angle of about 3° to about 12° measured from a planar surface parallel to an axial centerline and tangential to an outermost surface of the optical emitting fiber. In some embodiments, the tilted flat may have an angle of about 8° measured from a planar surface parallel to an axial centerline and tangent to an outermost surface of the optical emitting fiber. The tilted flat of some exemplary embodiments may be covered, and certain embodiments may include a lens and/or an antireflection coating over the tilted flat.

In an optical fiber having a mirror and a tilted flat, a substantial portion of light reflected from the optical emitting fiber is not recaptured by the fiber core, and the light exiting the optical emitting fiber may also be substantially free of astigmatism.

Embodiments of LCI in which an area or volume of a subject material is mapped or imaged is often known as optical coherence tomography (OCT). OCT systems can be designed to capture data in either the time domain or the frequency domain. An exemplary OCT system may be used for monitoring stent deployment.

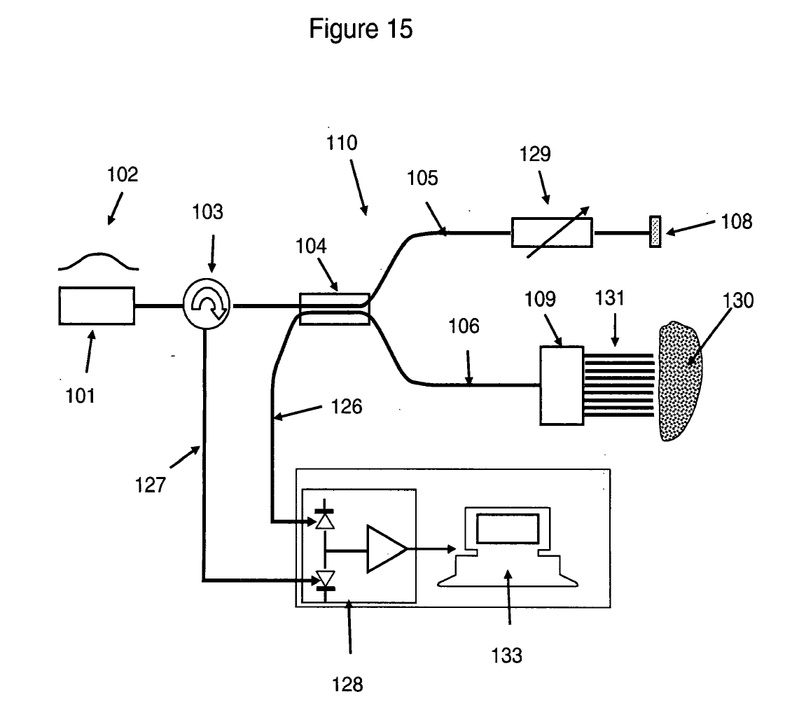

FIG. 15 is a schematic diagram of an exemplary interferometric system and more specifically of an all-fiber time domain OCT using a superluminescent diode (SLD) light source 101 having a relatively broad spectral width 102. The SLD light is applied to a circulator 103 and then to an interferometer 110, which includes of an optical splitter 104, which directs a portion of the SLD light to a reference path 105 and another portion of the SLD light to a sensing path 106 that provides the sensing light to a sample under test 130. The reference light is reflected by a reflector 108 through the reference path 105, and reflected or scattered light returned from the sample 130 through the sensing path 106 are recombined at the splitter 104. One component 126 is fed to one input of a balanced detector 128 where the returned reference light and sensing light interfere. Another component 127 of the returned reference light and sensing light is fed through the third port of the circulator 103 and provided to the other input of the balanced detector 128 where the reference and sensing lights also interfere. The time domain signal is the algebraic sum of the two interference signals.

A purpose of the balanced detector 128 is to reduce RIN, or common-mode noise, which is characteristic of a broadband light source such as the SLD. The signal from the balanced detector 128 may be further processed by a computer or processor 133 to yield data which characterizes the optical properties of the sample as a function of the depth of the scan, controlled by a variable delay in either the reference or sensing path.

An important characteristic of an interferometer is that an interference signal may be obtained only when the reference and sensing pathlengths are equal to within the coherence length of the light source. The coherence length of a light source is inversely proportional to the source's bandwidth. The bandwidth of an SLD is such that the coherence length is of the order of 10 to 15 microns. In a time domain system, the length of the reference path is adjustable, e.g., by introduction of variable delay 129 in one of the reference or sensing paths, and the relative lengths difference of the reference and sensing paths is calibrated. As the length of the reference path is scanned, the resulting signal represents a depth profile of the features within the sample with a detail resolution equal to the coherence length. This enables the OCT system to examine features within a sample with a resolution and accuracy of 10 to 15 microns.

The time domain interferometric system shown in FIG. 15 is configured with a multiple fiber system or a multi-core fiber 131, such that each fiber or each core element can probe a different region of a sample by directing light in the sensing path to one of the plurality of channels of the multiple fiber system or multi-core fiber by use of a switch 109. In cardiology, this structure enables a cardiologist to probe the lumen of an artery or enable the cardiologist to monitor stent deployment.

However, time domain OCT is relatively slow because the length of the reference arm is scanned mechanically. More recent OCT systems operate in the frequency domain. In this mode of operation, the reference arm length is kept constant and data acquisition is achieved by either scanning the frequency of a single-frequency tunable laser source or by using a broadband source and a spectrometer (such as a diffraction grating and a linear array of photodetectors) which diffracts the individual wavelength elements of the source over a linear array of photodetectors which can be sequentially addressed to produce an LCI signal. The two frequency domain systems are equivalent, and produce a signal in the frequency domain. The actual time domain data is obtained by a Fourier transformation of the frequency domain data.

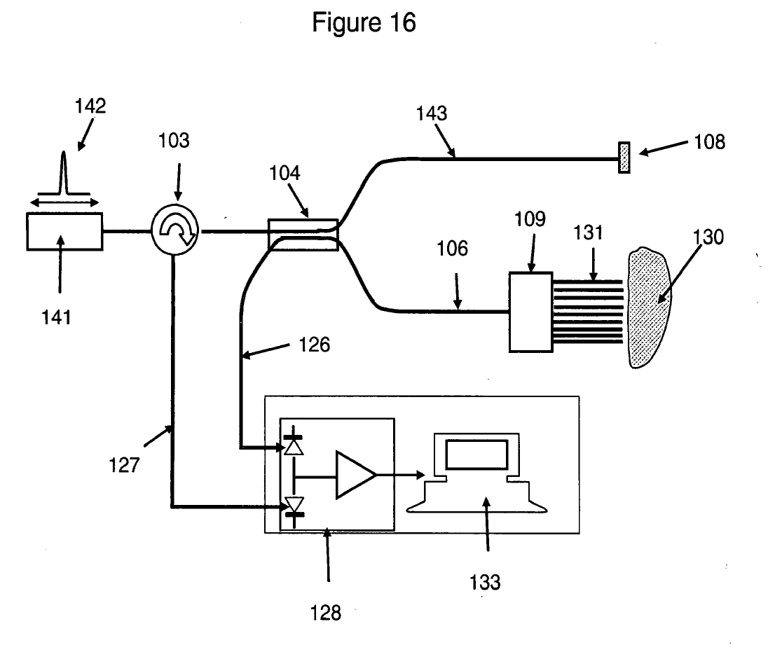

FIG. 16 is an exemplary embodiment of another interferometric system, and more specifically a scanned-frequency OCT (also called OFDI) (optical frequency domain interferometry). In such systems, the light source is a frequency-scanned laser 141 that emits a narrow spectral line that varies in wavelength 142 as the laser is scanned. The reference path 143 of an OFDI system is fixed in length.

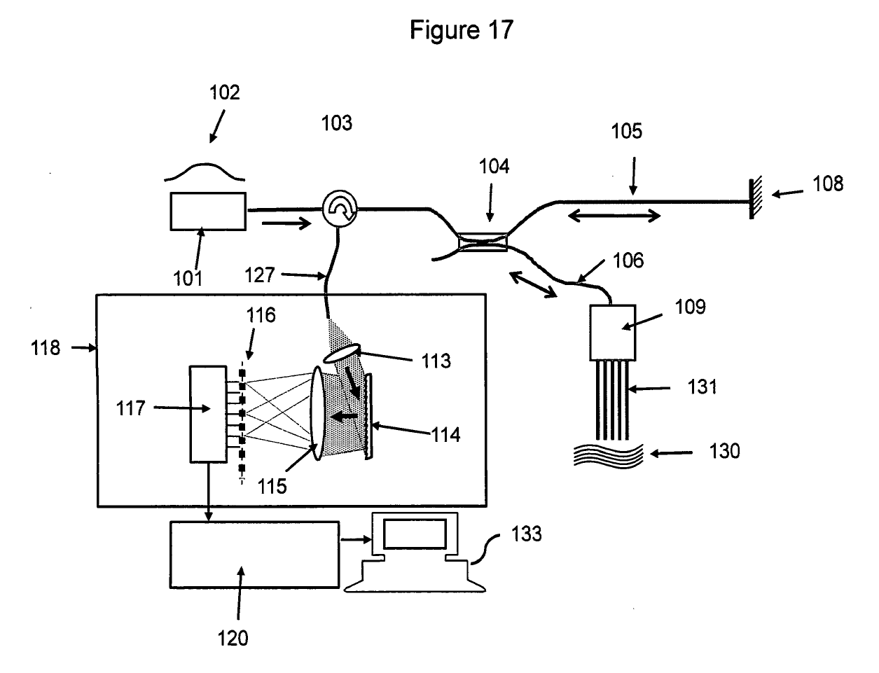

FIG. 17 is an exemplary embodiment of yet another interferometric system, and more specifically a spectrometer-based OCT, also called SD-OCT (spectral domain optical coherence tomography). In SD-OCT, a typical source is a SLD 101 having a broad spectrum 102. Reference path 105 is fixed in length, as for the case of OFDI. Light returned from the reference path 105 and light returned from the sensing path 106 are combined in splitter 104. A portion of the combined light is directed back to circulator 103, from which it is directed along a path 127 to an optical spectrometer 118. The optical spectrometer 118 depicted in FIG. 17 uses a lens 113 to expand the beam so that it is incident on a grating 114. Light diffracted from grating 114 is collected by lens 115 and directed to a detector array 116 wherein the position of each detector element in the array 116 corresponds to a narrow range of wavelengths diffracted by the grating 114. The signals from the detector elements are typically processed by electronics 117 and the detected signals are provided to receiver electronics 120, and then to a processor or computer 133 in which the data is converted to the time domain by Fourier transform.

The invention presented herein also includes a method for making a reduced reflection, lateral output optical fiber that includes providing an optical emitting fiber having a core and a cladding, forming a mirror at an end of the optical emitting fiber, and forming a tilted flat at an exit plane for light deflected by the mirror. The method may further include forming a tilted flat by removing a portion of the cladding to provide a flat surface at the exit plane, and the exit plane may be at about 90° measured from an axial centerline of the optical emitting fiber.

An exemplary embodiment of the invention also includes a method for reducing reflection and astigmatism of light exiting an optical emitting fiber at an angle other than 0 degrees. The method includes forming a mirror at an end of the optical emitting fiber, and forming a tilted flat at an exit plane for light deflected by the mirror. In some embodiments, the forming of a tilted flat may include removing a portion of the cladding to provide a flat surface at the exit plane.

FIGS. 2a and 2b are depictions of cross-sections of a fiber probe 2 made of a multi-core fiber, in which multiple higher-refractive index cores 3 are embedded in a lower-refractive index cladding material 4.

FIG. 2a shows a cross-section of an exemplary embodiment of a multi-core optical fiber 2a, in which a number (12 in the above diagram) of higher-refractive index fiber cores 3 are surrounded by lower-refractive index cladding 4 material that extends to the center of the composite multi-core fiber 2a.

FIG. 2b shows a cross-section of an exemplary embodiment of a multi-core optical fiber 2b having a hollow lumen 5, i.e., with no optical glass, plastic, or other optical cladding material extending to the center-line.

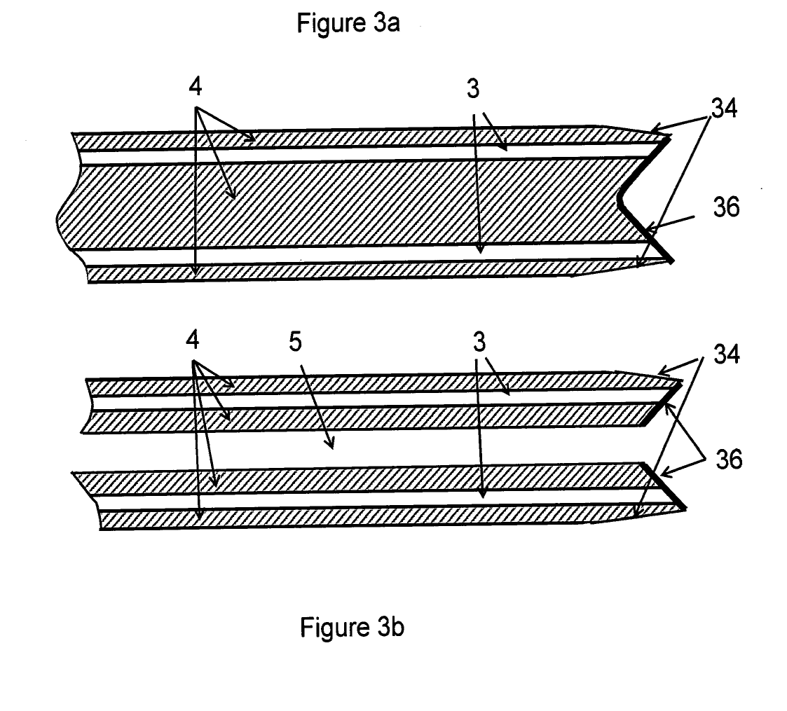

FIG. 3a and FIG. 3b are lateral views of an exemplary solid multi-core optical fiber 2a and an exemplary hollow multi-core optical fiber 2b, i.e., with no optical glass, plastic, or other optical cladding material extending to the center-line.

The number of cores used in a probe may be arbitrary up to a limit, depending on the diameter of the probe and the diameter of the core as discussed further below. In an embodiment in which the fibers are contained inside a 1-French guidewire, the number of cores that may be utilized with sufficiently low cross-coupling may be approximately 24, depending on the specific core diameter, refractive indices, and wavelength of light involved (e.g., see exemplary calculation below). In other embodiments, for example, where the fibers are housed in a catheter, the number of cores can be larger. For example, for a 1-mm diameter catheter with 5-micron-diameter cores embedded in the catheter wall, the number may be on the order of 100 optical fibers.

In the design of a multi-core fiber, it may be important to keep “cross-coupling” at an acceptable level. “Cross-coupling” is the coupling of light from a core to a nearby passive core. Since only one core may be active at a time, the effect of the cross-coupling is not the same as “cross-talk” where a signal from one channel affects a signal in an adjacent channel. Rather, cross-coupling represents optical power loss, and therefore affects the signal-to-noise ratio in the channel carrying the signal. Thus, it may be important to choose a channel separation (the spacing between adjacent cores) which will keep cross-coupling to an acceptable level.

Cross-coupling between two fibers is the result of an overlap between the optical fields that can be supported by the fibers. The fields are characterized by a longitudinal propagation constant β (a real number), an in-core transverse propagation constant kₜ (another real number) which caused an electric field to “bounce around” inside the core, and an “evanescent” constant γ outside the core (an imaginary number) which causes the field to decay exponentially at distances away from the core as exp(−γs), where s is the distance.

Cross-coupling may be calculated by use of a computer algorithm that has as inputs the core radius, wavelength, core refractive index and clad refractive index of each waveguide. For each, the effective index (nₑ), longitudinal propagation constant (β), transverse wavenumber inside the core (kₜ), and evanescent wavenumber (γ) are calculated by solving the eigenvalue equation for the lowest mode in each waveguide with the given parameters.

For a circular core, cylindrical coordinates are used and the solutions are Bessel functions inside the core and Hankel functions outside the core, with appropriate boundary conditions. The fields are then expressed in terms of their locations and their core-to-core separation (the distance comprising the two radii and the core-to-edge separation, s. The coupling coefficient κ is then obtained by calculating the overlap integral between the two fields over the cross-section of the second guide. Given U₁(y) as the field of the first guide whose center is at y=0, and U2(y) as the field of the second guide whose center is at 2a+s, the cross coupling is given by:

$$κ = \frac{1}{2} ( {n}_{1}^{2} - {n}^{2} ) \frac{{k}_{0}}{{n}_{e}} \frac{{\int }_{a + s}^{3 a + s} U 1 ( y ) U 2 ( y ) d y}{\int {U}_{1}^{2} ( y ) d y}$$

where n₁ is the core refractive index, n is the clad refractive index, nₑ is the effective index, kₒ=2π/λ, a is the radius of the guides, and λ the wavelength.

Consider two identical single-mode waveguides with the following characteristics:

| | |
|---|---|
| Core refractive index | n₁ = 1.45100 |
| Clad refractive index | n = 1.44782 |
| Core diameter | 2a = 9 μm |
| Core edge-to-edge separation | s |
| Wavelength | λ = 1.3 μm |
| Fiber length | L = 1 meter |
| Launch power in active fiber | Pₒ |

Then calculations using the above equations give the following:

| | |
|---|---|
| Calculated effective refractive | nₑ = 1.450035 |
| index | |
| Evanescent constant | γ = 0.3873 per μm |
| Coupling coefficient | κ = 2.4 × 10⁻³ exp (−γs) per μm |
| Power in launch core | P₁ = Pₒ cos² (κL) |
| Power in second core | P₂ = Pₒ sin² (κL) |
| Cross-coupling | $\frac{{P}_{2}}{{P}_{o}} = {sin}^{2} ( κ L ) or 10 Log [ {sin}^{2} ( κ L ) ] dB$ |

For a guidewire with 0.36 mm outer diameter (OD) and 0.3 mm inner diameter (ID), the following results are obtained:

TABLE 1

| Separation | | | Number of cores |
|---|---|---|---|
| (microns) | Cross-coupling | dB | in 0.3-mm ID guide |
| 15 | Too large | | 34 |
| 18 | 0.414 | −3.95 | 30 |
| 20 | 0.0675 | −11.8 | 28 |
| 25 | 7.07 ×10⁻⁴ | −31.5 | 24 |
| 30 | 7.38 × 10⁻⁶ | −51.3 | 21 |

In exemplary embodiments of the invention, any design parameters may be used. For example, the number of cores can be larger for a larger diameter guidewire. The number of cores in the 0.3-mm ID guide can be increased by choosing a multi-core fiber with a core diameter smaller than the value used for these calculations and using a clad with a slightly smaller refractive index than the one chosen above, or essentially using a multicore fiber with a larger core-clad refractive index difference.

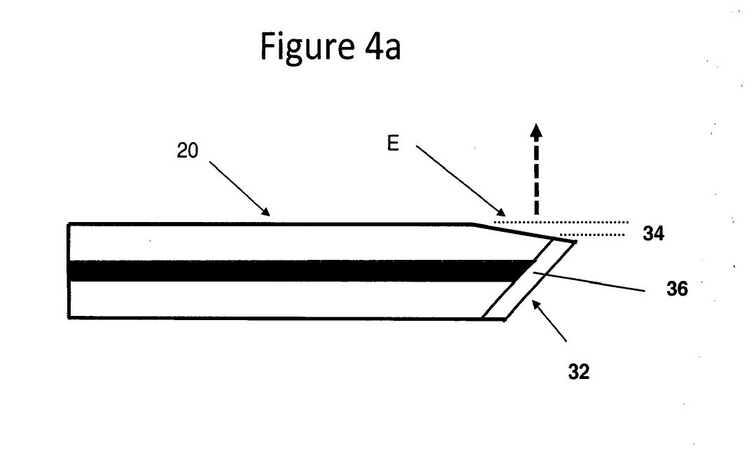

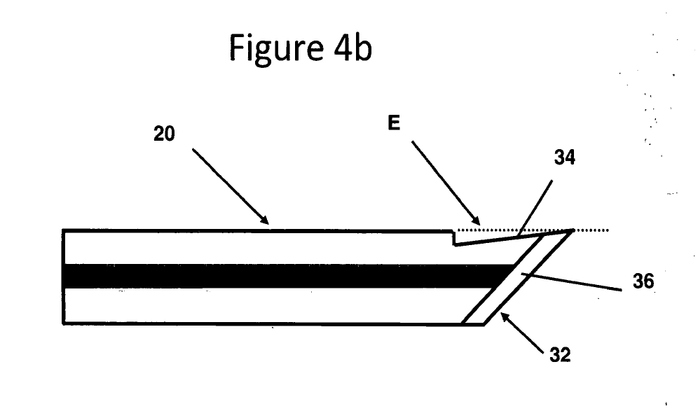

As illustrated in FIGS. 4a and 4b, an exemplary portion of a multi-core fiber probe 20 includes a tip 32. The tip 32 may include a mirror 36 integrated thereon, and a tilted flat 34. Such mirror 36 may include for example a thin layer of a metal (such as aluminum) or a stack reflector including several pairs of layers of two different refractive indices. The tilted flat 34 may be a ground-and-polished tilted flat at an exit plane E of the fiber probe. The flat portion of the tilted flat 34 acts to reduce or prevent astigmatism, and the tilt portion of the tilted flat 34 acts to prevent or reduce reflection. The tilted flat may be of any configuration.

For example, FIG. 4a illustrates a tilted flat 34 having a tapered configuration. Specifically, FIG. 4a shows an exemplary embodiment which details the reflecting and tilted planes formed with respect to each individual core of a multi-core fiber probe with a tapered tip. Alternatively, as illustrated in FIG. 4b, the tilted flat 34b may have a flare configuration. The flare can be made by a grinding and polishing process similar to the process for making the tilt. Specifically, FIG. 4b shows an exemplary embodiment which details the reflecting and tilted planes formed with respect to an individual core of a portion of a multi-core fiber probe 20 with a flared tip.

The tilt angle may be configured so that light reflected from the flat surface is directed away from the fiber tip 32 at the mirror 36 and only a negligible portion of light is back-reflected from the tilted flat 34 and captured by the fiber tip 32. In general, the cone angle of the light beam emitted by a fiber tip 32 is roughly equal to the numerical aperture (NA) of the optical emitting fiber. For example, a typical single-mode fiber at 1300 nm wavelength may have an NA of 0.12 radians (equal to about 7°). By reciprocity, any reflected light incident upon the fiber tip 32 within that cone would re-enter the fiber tip 32. The tilted flat 34 may prevent such reentry. By the principle of reflection, the magnitude of the reflection angle is equal to the magnitude of the incidence angle (“angle of reflection” is equal to the “angle of incidence”).

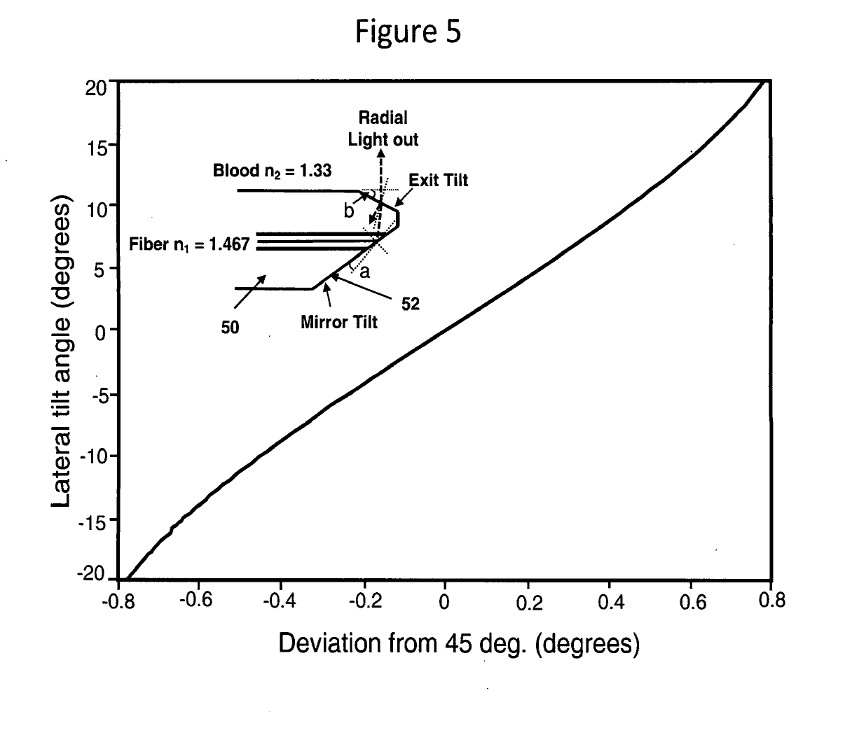

FIG. 5 is an exemplary plot of the relation between a tilt angle and a deviation of the mirror 36 from 45° to ensure a radial output of the light in blood or water.

That is, FIG. 5 illustrates an exemplary determination of the tilt angle of a titled flat 34. For an exemplary optical emitting fiber 50 shown in FIG. 5 having a mirror 52 positioned at a 45° angle at an end of the optical emitting fiber, the exit plane of reflected light, b, may be different from zero and the output angle may be off the radial direction by an amount a as specified by Snell's law (equation 1):

α=arcsin(n₁/n2 sin b)−b (1)

The radial output may be maintained by offsetting the mirror angle by an amount a from the 45° angle to reduce a to zero, and the relationship between the offset angle, a, and the tilt angle, b, may be given by equation 2:

a=1/2[b−arcsin(n₂/n₁ sin b)] (2)

A plot of the offset angle, a, and the tilt angle, b, for an interface between the edge of an optical emitting fiber having a refractive index n₁ of 1.467 and a medium having a refractive index for blood n₂ of 1.330 is provided in FIG. 5.

In practice, the correction, a, may not be needed if the deviation, α, is within the divergence angle of the light beam. The beam divergence is about 7°, and a value of a less than about 2° is acceptable. By this criterion, for example, no correction may be needed if the tilt angle is less than about 20°. For larger tilt angles up to about 65°, an offset correction may be needed.

Adjusting the tilt angle may also reduce reflection by allowing index matching of the cladding material of the optical emitting fiber and the media through which the light travels, thereby eliminating the need for an anti-reflection coating on the optical fiber tip. Normally, the reflection coefficient, R, between two media of refractive indices n₁ and n₂ is given by equation 3:

R=[(n₁−n₂)/n₁+n₂)]² (3)

For the fiber-blood interface case, the reflection coefficient is about 0.24% or −26 dB. For many applications, this value may be too high and may be reduced by index matching. For example, a quarter-wave anti-reflection (AR) layer may be used for index matching. In the particular case of fiber-to-blood, the required index of the AR layer may be 1.4 which is not commercially available, and for interferometry using high-power broad band sources, a reflection below 0.01% or −40 dB is preferred. Tilting may achieve this index matching effect without the use of AR coatings. Thus, a tilt may be used to reduce the effective reflection to values that are below the normal index mismatch and that cannot be attained by an AR coating.

The effective reflectivity of the tilted flat depends on the optical mode profile, the refractive indices, the tilt angle, and the distance of the tilt plane from the fiber core. Calculations used for the design of superluminescent diodes using the tilted facets show that the reflectivity drops slowly for angles below about 4°, then drops rapidly for larger angles. For example, a rough calculation indicates that the reflectivity at 4° angle is of the order of 0.1% (or −30 dB) under conditions similar to the fiber-blood case, and a reflectivity of less than 0.001% or −50 dB may be achieved for an 8° tilt.

An exemplary maximum allowed angle is the angle of total internal reflection between the input and output media, provided that adequate off-radial compensation is made by offsetting the mirror angle from the nominal 45° angle and is 65° and the maximum mirror offset is 4.88° for the optical fiber-to-blood system exemplified above.

Finally, a tilt angle may be used at which mirror offset is not necessary where the output deviation from the radial direction is significantly less than the beam divergence angle. For example, a radial deviation of about 2° may be considered acceptable. For the fiber-to-blood system exemplified above, the tilt range for unnecessary correction is from about 4° to about 20°. In particular, an 8° tilt is adequate to provide a sufficiently low reflectivity with a 45° angle within a reasonable tolerance of less than ±1°.

In an exemplary embodiment, tilted flat 34 (see FIGS. 4a and 4b) may be formed on an optical emitting fiber by removing a section of cladding material at the exit surface E of light deflected by a mirror 36 formed at an end of the optical emitting fiber and processing that surface to a tilted flat from the fiber-clad normal exit surface. A tilted flat 34 as described above may reduce or eliminate reflection and astigmatism of an optical fiber for lateral output of light, and the reduction or elimination of reflection and astigmatism may substantially reduce noise in the light signal propagated by the fiber.

The tilted flat 34 of the an exemplary embodiment of the invention may also include a covering of any material known in the art that allows light to be transmitted through without altering, eliminating, or absorbing the light. Non-limiting examples of such materials include glass, polymers, plastics, and combinations thereof. The covering may be attached to the probe using any method known in the art including, but not limited to, optical cement, epoxy or other compounds capable of attaching the flat to the probe and the like. The covering may be a lens for collimating or focusing the light to a certain distance. In other exemplary embodiments, the tilted flat 34 may be coated with an anti-reflective coating which may further reduce reflection of light exiting the fiber back into the fiber core.

The tilted flats should be properly aligned with the cores. One approach is to approximate the required plurality of flats by a cone or by shaping the entire tip of the multi-core probe to be in the form of a lens. F

For example, a conical “V” at the tip, shown in FIGS. 3a and 3b, can be filled with epoxy and ground to form the shape of a lens. The curvature of the lens partially offsets the astigmatism introduced by the “V” by creating a surface with an approximately 8° angle where the light beams are emitted from the outer surface of the multi-core probe and approximately satisfy the condition for providing outputs perpendicular to the arterial wall. A transmissive surface, tilted at approximately 8 degrees, may prevent reflections back from the fiber tip that would degrade signal-to-noise and dynamic range.

The mirror 36 on the tip may be made by any means familiar to the art and may be, but is not limited to, an evaporated metal, or a multi-layer interference mirror made from two or more dielectrics. In general, a mirror may be placed at an end of an optical emitting fiber, and an angle at which the mirror 36 is ground may be measured from a planar surface perpendicularly intersecting an axial centerline of the optical emitting fiber. The mirror 36 may be ground at an angle and may deviate slightly from the desired angle in one direction or another in order to compensate for the effect of the tilt on the radial output of the fiber. For example, in an exemplary embodiment, the mirror 36 may be ground at an angle which deviates slightly from 45° to allow light to exit the fiber at an angle of about 90°.

An exemplary embodiment includes laterally deflecting light from a fiber probe while minimizing reflection and reducing or preventing astigmatism from the exit plane of the fiber probe, and in certain embodiments, the fiber probe may be used in a probe system. For example, a catheter or guidewire may be used to probe an arterial lumen and to measure dimensions of the arterial lumen and accurately deploy a stent into the region.

Another exemplary embodiment is directed to a method for determining a size of a vessel lumen by use of optical radiation. An exemplary embodiment of the method includes an interferometric method that includes utilizing optical radiations of coherence length, for example, shorter than approximately 20 microns, or in some embodiments, less than about 10 microns. The resolution (e.g., the ability to distinguish adjacent features) of an interferometer is determined by the coherence length of the light source. For example, a light source having a coherence length of 20 microns provides for a resolution of about 20 microns. The LCI reflected signal, which allows the size determination of an artery, may also be used to determine the linear distance of the optical emitting fiber to a stent being deployed on a balloon, as well as a linear distance to the lumen wall. These linear dimensions, which are obtained by analysis of specular reflections received by the optical emitting fibers allows for the determination of a cross-sectional area, and from that area, the diameter to which a stent should be expanded.

A further exemplary embodiment is a method of using received reflections from within an artery and calculating dimensions from such data to determine the size of a stent expansion in real-time as well as the size of the lumen. By use of feedback and/or other signal processing in real-time, stent expansion may be stopped during a process when a desired expansion size is achieved without exceeding a maximum diameter of the lumen. For example, the stent expansion may be controlled manually by a physician or alternatively may be controlled by an automated software system. Additionally, the software system may include a failsafe mechanism, whereby expansion of a stent cannot exceed a maximum size, the maximum size being the measured diameter of the lumen of the artery.

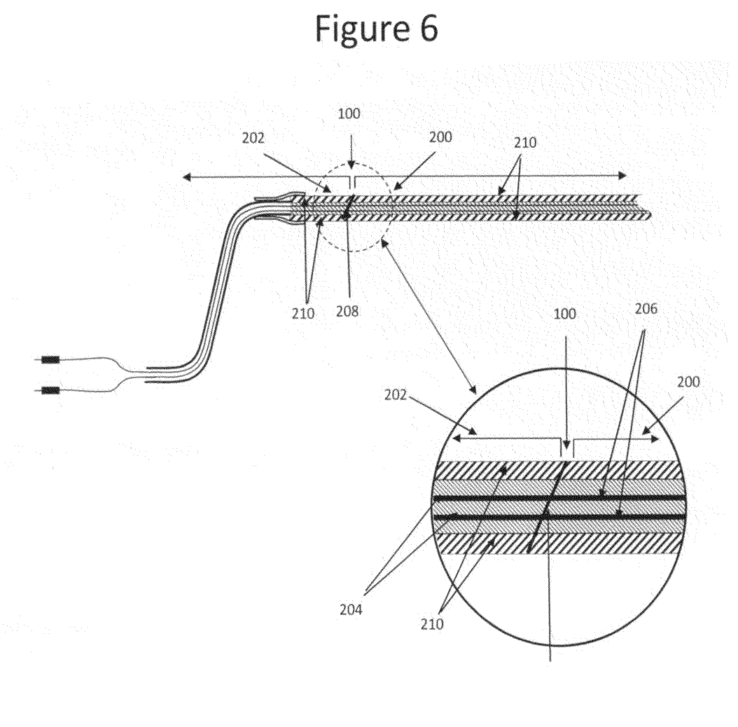

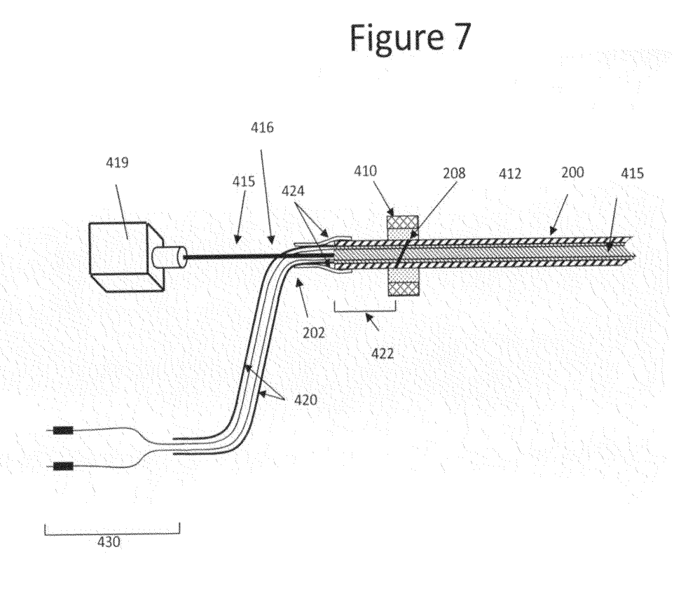

The multi-core probe may be connected to a multi-core umbilical optical fiber to facilitate use in practical applications, such as in cardiac catheterization procedures, in which access to the proximal end of the guidewire is required so that a balloon catheter with or without a stent can be deployed over the guidewire. FIGS. 6 and 7 illustrate the components of exemplary connecting mechanisms for a multiple fiber probe. Indeed, the dimensional stability of the multi-core probe should be at least as good, if not better, than an assembly of individual single-mode fibers.

As illustrated in FIG. 6, a connector 100 of an exemplary embodiment of the invention includes a structure by which the separate components of an optical probe meet at a mating interface 208 and may include a guidewire probe 200 having a multi-core fiber with a plurality of optical emitting cores 204 and a linking component 202 having optical fiber feed lines or a section of a multiple core fiber with cores corresponding to each of the plurality of optical emitting cores 204 of the guidewire probe 200.

The linking component 202, as illustrated in FIG. 6, may operably link the guidewire probe 200 to a power source and/or a detector. The fiber probe made of a multi-core fiber in the guidewire probe 200 has cores 206 corresponding to optical fiber feed lines or a multiple core fiber 204 in the linking component 202 meet at a mating interface 208 that has been cut and polished at an angle. The angle may be arbitrary or an exemplary embodiment may be between about 3° to about 20° and, in particular exemplary embodiments, may be about 8° as measured from a plane perpendicular to an axial centerline of the guidewire probe.

In an exemplary embodiment of the invention, the interface 208 may be formed by ends of two separate multi-core fibers formed with complementary angles.

In an exemplary embodiment, the angled interface 208 may provide a two-fold advantage over an interface cut perpendicularly to an axial centerline of a guidewire. First, the angled interface 208 may provide a low-reflection junction between the plurality of cores 3 and the optical feed lines 206 reducing back-reflection in the optical emitting fiber. Second, the angled interface 208 may allow for self-alignment of the plurality of cores 3 with the optical feed lines 206 because the guidewire probe 200 and the linking component 202 can be mated and aligned at the angle of the angled interface 208. Therefore, each of cores 3 may be automatically mated with its corresponding optical fiber feed line 206. In an exemplary embodiment of the invention, optical feed lines 206 are made up of cores in a multi-core fiber.

The second advantage mentioned above may include using the angled surfaces of the polished facets of the two resultant multi-core elements to force mechanical alignment between corresponding cores of the linking element and probe element. It also uses the angled interface, as a structure for providing low reflection so that unwanted reflections from that interface do not return to the interferometer, which would be a source of noise that reduces the signal-to-noise ration and dynamic range of the instrument.

The range of angles may, however, be contemplated to be greater than the 20-degree upper limit suggested above. That is, the upper limit may be any physically achievable angle (e.g., 45 degrees or, perhaps, even 60 degrees) with the purpose being to effect mechanical/optical alignment between corresponding cores. A problem of reducing reflections from that interface, 208, may be dealt with by other means. For example, each of the two newly formed optical faces (of the linking element and the probe element) may be anti-reflection coated. This may require a multilayer dielectric stack to achieve adequately low reflection coefficients, but such techniques are well-known. Alternatively, a small gap between the two optical faces may be filled with an index-matching material (e.g., a fluid that is characterized by the same, or about the same, refractive index as the glass of the cores themselves). Either technique may allow mechanical/optical alignment while providing low reflection from the interface.

In an exemplary embodiment of the invention, the optical fiber is affixed within the hollow tube so that it does not move either during or following the cutting operation.

In an exemplary embodiment, the affixing of the optical fiber to the hollow tube may be performed in several ways. One way would be to form one or more small holes through the hollow tube at or near the location where the cutting operation will be performed, to inject or otherwise provide an adhesive through the hole(s), to allow the adhesive to set, thereby affixing the optical fiber to the inner wall of the hollow tube, and to cut the integrated assembly at the location desired to form the faces on the then-formed linking element and probe element to subsequently form interface 208 when mated.

In an exemplary embodiment of the invention, a unified assembly of a multi-core fiber housed within a hollow tube 210 is cut at an angle. The two resulting ends, the proximal end of the probe guidewire and the distal end of the linking element, which may also be considered an umbilical connector that communicates signals between the multi-core probe and an interferometric instrument. These two newly formed ends are subsequently polished so that they may be mated within an external mechanical connector that is permanently affixed to the linking element and is detachably connectable to the probe. In this manner, when the probe is de-attached from the linking element, other catheter-based devices may be slid over the proximal end of the probe guidewire and deployed towards the distal end of that probe guidewire. An example is a coronary balloon catheter with or without a stent.

In an exemplary embodiment of the invention, the mechanical connector engages the probe guidewire, the angled facet of the probe is brought into intimate contact with the mating angled facet of the linking element. The mechanical connector constrains the two parts of the multi-core optical fiber such that they are co-linear (i.e., not laterally displaced from one another) and can only be oriented in one angular direction with respect to one another. When the two parts are so constrained, the individual cores of each part of the multi-core optical fiber are forced to align with one another, insuring that signals from the light source within an interferometric instrument that are provided to the proximal ends of the cores of the multi-core linking element are communicated with high efficiency (i.e., relatively little optical loss) to the corresponding cores of the multi-core probe element.

As illustrated in FIG. 7, in some exemplary embodiments, a locking mechanism or knob 410 may be placed around at least a portion of the connector 100 to facilitate a secure connection between the guidewire probe 200 and the linking component 202.

In particular embodiments, no part of the guidewire probe 200 or the connector 100 may exceed the diameter of the guidewire. For example, the guidewire may have a notch 412 or an internal or embedded appendage that facilitates alignment or locking, but no part of the guidewire probe 200 or appendage attached to the guidewire probe 200 should exceed the diameter of the guidewire. By limiting the diameter of the guidewire probe 200 and eliminating appendages that may increase the diameter of the guidewire probe 200, secondary devices or probes may be easily placed over the guidewire probe 200 during use. Therefore, the need to reconfigure or remove the guidewire probe 200 from the lumen being examined during examination is eliminated.

In exemplary embodiments, as illustrated in FIG. 7, the guidewire probe 200 may further include a central wire or tube 415 inside of hollow lumen 5 around which cores 3 are arranged. The linking component 202 in such embodiments may further include a hole or opening 416 through which the central guidewire or tube 415 may pass. The central wire or tube 415 may remain accessible to the user of the guidewire probe, and the user may manipulate the central wire or tube to affect a change in the guidewire probe 200 or to operate an optical probe head 418 attached to the guidewire probe 200.

For example, the user may use the central guidewire 415 to manipulate the optical probe head 418 or cause the guidewire probe 200 to bend. In further embodiments, the central wire of tube 415 may be attached to another device 419 such as, for example, an actuator, controller, air compressor and the like, which mechanically manipulates the central wire or tube or an optical probe head 418 attached to the distal end of the guidewire probe 200.

In still other embodiments, the linking component 202 may further include a flexible boot or jacket 420 encapsulating the optical feed lines 206 but allowing greater flexibility of the optical feed lines 206 than the guidewire probe 200. In such embodiments, a guidewire section of the linking component 422 may include a section of guidewire identical to that of the guidewire probe 200 in which the fiber probe 2 is arranged as in the guidewire probe 200. The guidewire section of the linking component 422 may extend from the angled interface 208 to some distance past a locking component 410. The optical feed lines 206 may extend past the end of the guidewire section of the linking component 422 and may be encapsulated by the flexible boot or jacket 420 which extends from, and may be continuous with, the guidewire section of the linking component 422.

In some embodiments, the interface between the guidewire section of the linking component 422 and the flexible boot or jacket 420 may further include a strain relief boot 424 that may be connected to both the guidewire section 422 and the flexible boot or jacket 420. The strain relief boot 424 may include a substance having stiffness greater than the flexible boot or jacket 420 but less than the guidewire section of the linking component 422, and may provide support for the optical feed lines 206 during bending to ensure that the optical emitting fibers do not bend excessively causing distortion of the signal or breakage of the optical emitting fibers. The flexible boot or jacket 426 may extend from the interface between the guidewire section of the linking component 422 to the proximal most part of the optical feed lines 206 extending beyond the end of the flexible boot or jacket 420 at a linking component terminus 430 of the linking component 202.

In another exemplary embodiment the linking component 202 includes a multi-core fiber which connects to the multi-core fiber 2 such that cores 3 align with the cores of the multi-core fiber of linking component 202.

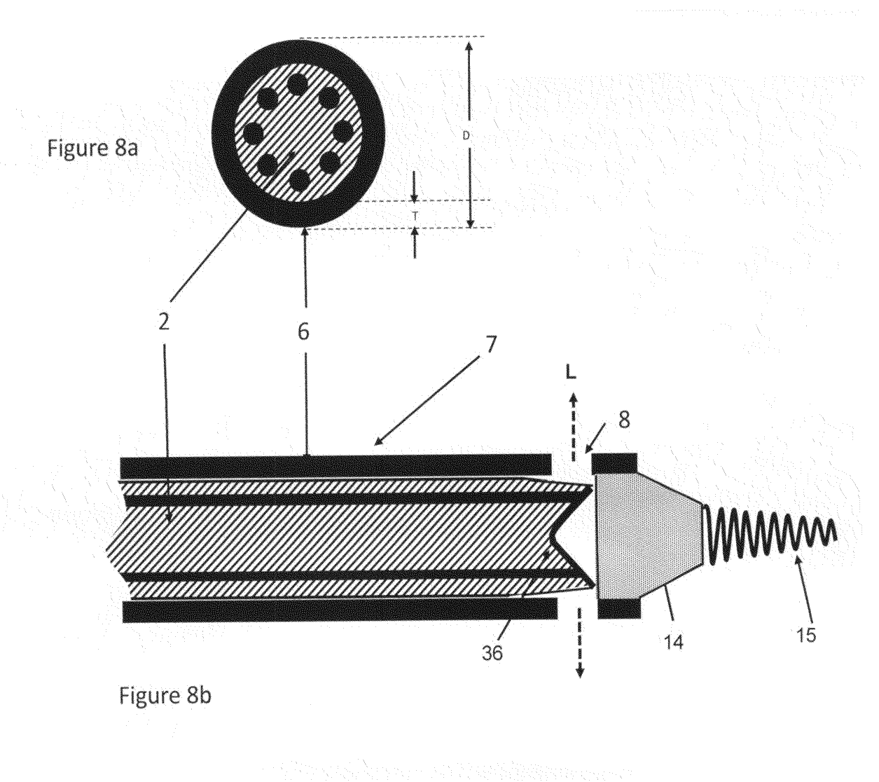

FIGS. 8a and 8b illustrate another exemplary embodiment of the invention in which the multi-core fiber probe 2 is housed in a hollow tube 6 to form a guidewire 7. Such a guidewire may be suitable for cardiac catheterization procedures.

FIGS. 8a and 8b are consistent with the solid multi-core fiber shown FIGS. 2a and 3a. An exemplary embodiment may also include the hollow probe configuration shown in FIGS. 2b and 3b. As illustrated in FIG. 8a, an exemplary, non-limiting, diameter D of the hollow tube 6 is approximately 0.014″ and an exemplary, non-limiting, thickness T of hollow tube 6 is approximately 0.0018″.

The hollow tube 6 may include any suitable material, e.g., metal, plastic, composites, combinations thereof, etc. Hollow tube 6 also may include output portals 8. Exemplary output portals 8 include windows 9 made of small lenses or the like.

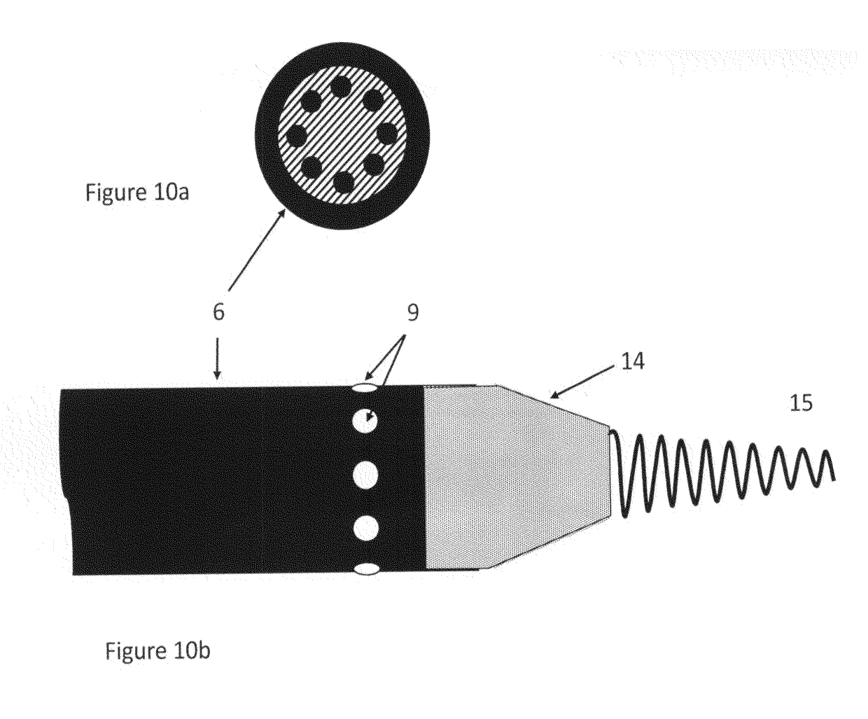

As illustrated in FIGS. 10a and 10b, the hollow tube 6 may be comprised of any suitable material, e.g., metal, plastic. Hollow tube 6 also may include output portals 8. Exemplary output portals 8 include windows 9 made of small lenses.

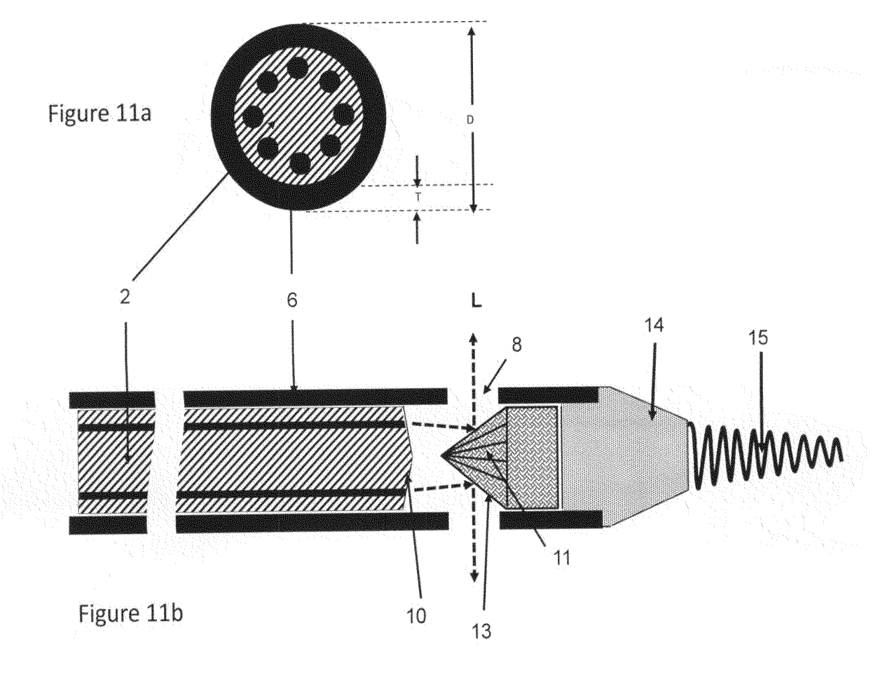

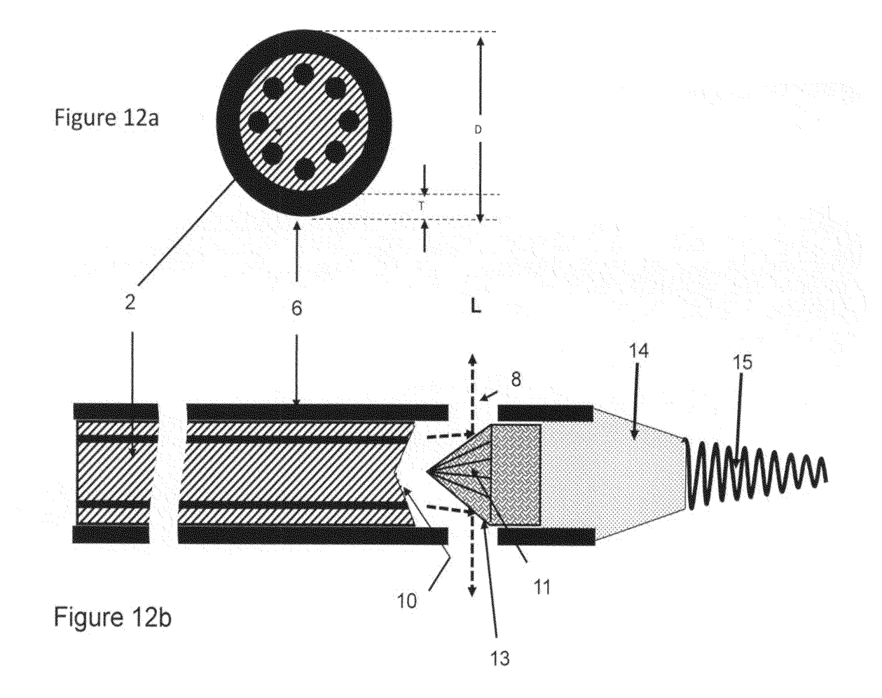

For use in medical catheterization procedures, the multi-core probe may be assembled inside a hollow guidewire (e.g., tube) 6. Two exemplary embodiments are shown in FIGS. 11a and 11b and FIGS. 12a and 12b for coronary catheterization procedures, in which a multi-core fiber probe is assembled inside a hollow (in an exemplary embodiment 0.014″ diameter) tube to function as a guidewire. Note that only the distal end of the assembly is shown.

The tip 10 of the multi-core fiber is processed to form either a convex (FIG. 11b) or a concave (FIG. 12b), having a tilt angle of approximately 8° with respect to the light traveling in the fiber cores. The 8° surface, whether concave or convex, may be formed as either separate facets (e.g., by grinding and polishing) so that each facet is flat, or as a cone (e.g., a continuous cone), so as to impart a small degree of refractive power to the light beams. The 8° tilted surface prevents light reflecting from that surface from re-entering each respective core 3 of the multi-core fiber 2, thereby substantially reducing undesired light that would degrade the signal-to-noise and dynamic range of the instrument (e.g., an interferometer for optical coherence tomography or a spectrometer for spectroscopy). The multiple beams of light L that emerge from the processed tip 8 of the multi-core fiber 2 propagate towards a multifaceted mirror prism reflector 11 which may be formed of a short section of fiber 12 of the same or similar diameter as the multi-core fiber 2 (and which may be a small section of that same multi-core fiber) such that light incident on the prism facets 13, angled at approximately 45°, will laterally deflect the light at approximately 90° towards the arterial wall. The prism facets 13 may be coated to increase reflectivity.

In the FIG. 8b, the output light L emerges through output portals 8, each aligned with a respective core 3 of the multi-core fiber 2. The output portals 8 may be holes formed around the circumference of the hollow tube 6, or may include an optical window 9 (e.g., made of glass, polymer, or other optical material) that may be flat or angled (again to reduce unwanted reflections into the cores of the multi-core fiber) or formed into a positive or negative lens.

The output portals 8 are aligned with the output light emerging from the guidewire. The hollow tube 6 including the exterior of the device may be any suitable metal, plastic, and/or other material. The assembly is completed by including a nose piece 14, which prevents blood (or another substance) from entering the distal end of the multi-core probe 2, and terminated in a flexible tip 15, which is a standard feature of many coronary guidewires and which allows manipulation by an interventional cardiologist to a target artery as well as reduces the possibility of inducing damage to the artery wall.

FIGS. 12a and 12b illustrate a configuration using an approximately 45° multi-facet prism reflector placed at a short distance from the distal end of the multicore fiber. This distance should preferably be such as to minimize the distance between the distal end of the multicore fiber and the surface of the sample under test. In an exemplary embodiment, it should be less than about one millimeter. This distance can be minimized by allowing the prism tip to touch the distal end of the multicore fiber. The distance can be further reduced by grinding the tip of the prism to shorten the distance from the cores to the reflection point on the prism. Since the prism 11 is external to the multi-core fiber 2, a means is used to considerably reduce reflection. An exemplary way to accomplish this is by depositing an AR (anti-reflection coating) layer 16 on the distal end of the multi-core fiber 17, processed in this example to be at 90°, so that the light paths L emerge undeflected. This could be used for embodiments having output portals 8 formed of simple holes or windowed output portals in which the windows 9 are AR-coated, tilted, or have curved optical output surfaces designed to reduce unwanted reflections. Holes in the hollow tube 6 can be formed by laser drilling or other techniques.

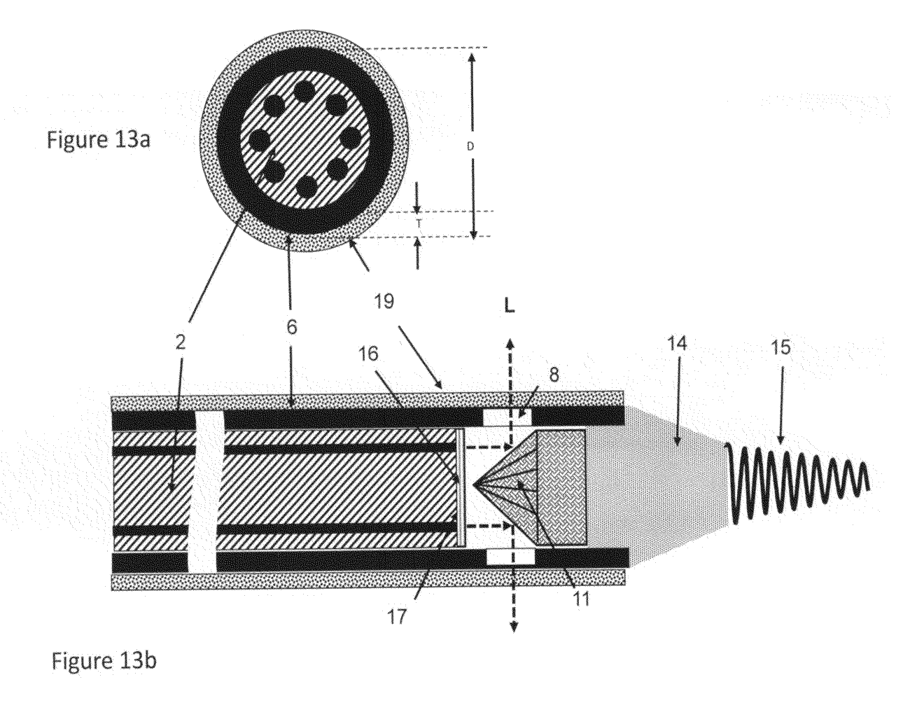

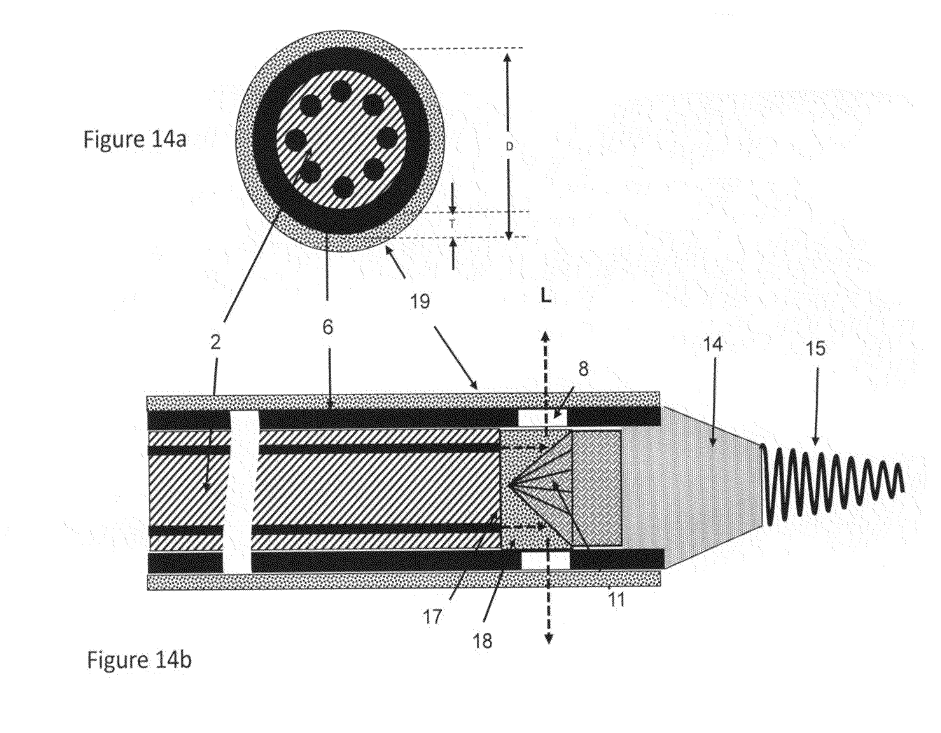

Additional exemplary embodiments of the invention include multi-core fiber lateral output probes as shown in FIGS. 13a and 13b. In an exemplary embodiment, an anti-reflection (AR) coating 16 (instead of an angled, tilted surface) on the distal tip 17 of a multi-core optical fiber 2 may be used to reduce unwanted reflections into the cores 3 of the multi-core fiber 2.

In an exemplary embodiment, use of index-matching materials 18 between the distal (uncoated) tip of the multi-core optical fiber 2 and the multifaceted mirror prism 11 may be used. In this embodiment, the facets 13 of the multifaceted prism may be at an angle other than 45°.

In an exemplary embodiment, windows 9 made of glass, polymer (plastic) or other optical material may be used to isolate the multi-core fiber probe 2 from its working environment, such as blood flowing in coronary arteries.

In an exemplary embodiment, a thin sheath 19 may be used to isolate the multi-core fiber probe 2 from its working environment, such as blood flowing in coronary arteries. The sheath 19 may be able to perform the function of the window 9.

In another exemplary embodiment, as illustrated in FIGS. 14a and 14b, the space between the 90°-processed distal tip 17 of the multi-core optical fiber 2 and the multifaceted prism is filled with an index-matching material 18. The index-matching material 18 may be a fluid, gel, and/or other filler material having an appropriate composition for index-of-refraction matching.

In an exemplary embodiment, the filler material is index-matched to the index-of-refraction of the multi-core fiber. One such matching index material is deuterated polyfluoromethacrylate, which can be synthesized by adding chlorine in a proper amount to polymethylmethacrylate (PMMA), and which is hardened by polymerization with heat or ultraviolet light. As an example, by changing the fluorine content from 0% to 50%, any refractive index between 1.50 and 1.35 can be obtained. This is desirable because the refractive index of the silica used for the multi-core fiber is around 1.45. The use of an AR-coating on the distal end of the 90°-processed multi-core fiber 2 is not necessary in this embodiment as there is not an index-of-refraction discontinuity there to cause reflections back into the cores 3.

In another exemplary embodiment, the surfaces of the multifaceted prism 11 are formed so that they are not precisely at 45°, thereby causing the output light to deflect at an angle that is not precisely 90°. Thus, any reflections from interfaces, e.g., a flat window, that are parallel to the direction of the long dimension of the probe will be offset and not return to the core 3 of the multi-core fiber from which it was emitted.

As mentioned above, the output portals 8 of the guidewire are preferably isolated from the working environment. This may prevent contamination of the optics (e.g., from blood). Such windows (portals) 9 can be made of any optical material that is transparent at the wavelengths of light interest, e.g., various glasses or plastics. The window 9 can be flat, in which case it is preferably AR-coated, or tilted at an angle to cause any unwanted reflected light to be directed away from the fiber-optic core from which it was emitted. Additionally, the window 9 can be formed to have curved optical surfaces (i.e., surfaces in which a refractive index discontinuity exists, such as between plastic and air or water or blood) so that reflections from the optical surface spread substantially before returning to the multi-core fiber, thereby reducing their intensities to negligible levels.

As an example, the space between the distal tip 17 of the multi-core fiber 2 and multifaceted prism 11 may be filled with index-matching polymer 18 such that the polymer extends through holes in the hollow tube and forms small lenslets (e.g., of the order of 50-micron diameter) that act as windows 9. The radius of curvature of the outer surface of the lenslets may be chosen such that reflections from that surface expand so that negligible light levels are reimaged on the core from which that light was emitted. For example, a small amount of material can be added to form a miniature converging lens over the window. Such controlled amount of material can be deposited by means of a micropipette which can deposit tiny drops of material of volume that can be controlled from less than one microliter to about one milliliter.

In an exemplary embodiment, a polymer sheath 19 (see FIGS. 13a-14b), made of materials that are optically transparent at the wavelengths of interest, may be used to seal the output portals, whether simple holes or windows, to prevent blood from entering the probe area. As an example, the sheath 19 may include or be formed of transparent thin-walled heat-shrink tubing, which seals the edges of the window. Such a sheath 19 can be used in conjunction with the embodiments of the invention in which tilted surfaces on the multi-core fiber are formed to prevent unwanted reflections from re-entering the core from which the light was emitted.

The use of a multiple core fiber of the exemplary embodiments may have improved fabrication properties as opposed to a fiber probe having multiple single fibers.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A multi-core optical fiber probe, comprising:
a multi-core optical fiber including a plurality of cores adjacent a cladding material;
a plurality of angled reflectors disposed respectively at distal ends of the cores;
wherein an angled reflector of the plurality of angled reflectors deflects light propagating in a core at a deflection angle that is different from an axis of light propagation in the core, and
wherein light propagating toward a distal end of the core of the multi-core probe is emitted, after reflection by the angled reflector, out of the multi-core optical fiber probe.

2. The multi-core optical fiber probe according to claim 1, wherein the light propagating toward the distal end of the core of the multi-core probe is emitted, after reflection by the angled reflector, through an exit surface near a distal end of the multi-core fiber, and
wherein the exit surface is configured to reduce a coupling of incident light on the exit surface back into a corresponding core without affecting light reflected or scattered back from an object outside the exit surface.

3. The multi-core optical fiber probe according to claim 1, wherein the plurality of angled reflectors are disposed such that a core of the plurality of cores terminates at a corresponding angled reflector of the plurality of angled reflectors formed at a distal end of each core.

4. The multi-core optical fiber probe according to claim 1, wherein the reflector comprises a metalized conical V-shaped pattern at a distal end of the multi-core optical fiber to provide deflection for lights from each of the cores in the multi-core optical fiber.

5. The multi-core optical fiber probe according to claim 1, wherein the cladding material comprises a single cladding material surrounding each of the plurality of cores.

6. The multi-core optical fiber probe according to claim 4, wherein the V-shaped pattern angle is disposed at approximately 45 degrees with respect to the axis of light propagation in a core so as to deflect light at approximately 90 degrees from the axis of light propagation in the core.

7. The multi-core optical fiber probe according to claim 2, wherein the exit surface is formed on a radially outer surface of the multi-core optical fiber.

8. The multi-core optical fiber probe according to claim 2, wherein the exit surface is tilted at an angle with respect to a lateral direction of an outer surface of the cladding material, the angle being in a range between about 3 degrees to 20 degrees.

9. The multi-core optical fiber probe according to claim 8, wherein a tilt angle of the exit surface is approximately 8 degrees with respect to the lateral direction of the outer surface of the cladding material.

10. The multi-core optical fiber probe according to claim 2, wherein each exit surface of the cores comprises a plane.

11. The multi-core optical fiber probe according to claim 2, wherein each exit surface of the cores is curved so as to form a lens.

12. The multi-core optical fiber probe according to claim 2, further comprising a hollow tube surrounding the multi-core optical fiber.

13. The multi-core optical fiber probe according to claim 12, wherein the hollow tube comprises a cardiovascular guidewire.

14. The multi-core optical fiber probe according to claim 1, wherein a proximal end of the multi-core optical fiber comprises a first section including a first angled end face and a second section including a second angled end face, and
wherein the first angled end face is joined to the second angled end face by a connector.

15. The multi-core optical fiber probe according to claim 12, wherein the distal end of the hollow-tube guidewire includes an array of transparent windows facing the exit surface.

16. A low-coherence interferometric system comprising:
a light source;
an optical splitter splitting a light from the light source into first and second light portions;
a reference arm receiving the first light portion;
a sensing arm receiving the second light portion; and
an optical switch coupled to the multi-core optical fiber probe according to claim 1.

17. The system of claim 16 configured as a time domain optical coherence tomography system with the reference arm comprising a scanning reference arm length.

18. The system of claim 16 configured as a frequency domain optical coherence tomography in which frequency components of an interferometric signal is provided by the light source, the light source comprising a frequency scanned light source.

19. The system of claim 16 configured as a spectral domain optical tomography system in which a spectral component of a signal is provided by a dispersive medium and an array of photodetectors coupled to the reference arm and the sensing arm.

20. The multi-core optical fiber probe according to claim 1, wherein the plurality of angled reflectors comprise a reflector member disposed such that a gap is provided between a distal end of the multi-core optical fiber and the reflector member.

21. The multi-core optical fiber probe according to claim 20, wherein the reflector member comprises a multifaceted prism.

22. The multi-core optical fiber probe according to claim 20, wherein a filler material is disposed between the reflector member and the distal end of the multi-core optical fiber, the filler material having an index of refraction substantially the same as an index of refraction of the core of the multi-core optical fiber

23. The multi-core optical fiber probe according to claim 21, wherein the distal end of the core of multi-core optical fiber comprises an anti-reflection coating.

24. A method of manufacturing a multi-core optical probe, the method comprising:
providing a multi-core optical fiber including a plurality of cores adjacent a cladding material; and
disposing a plurality of angled reflectors respectively at a distal ends of the cores;
wherein an angled reflector of the plurality of angled reflectors deflects light propagating in a core at a deflection angle that is substantially different from an axis of light propagation in a core, and
wherein light propagating toward a distal end of the core of the multi-core probe is emitted, after reflection by a respective reflector, out of the multi-core optical fiber probe.

25. The method according to claim 24, further comprising:
shaping a distal end face of the multi-core optical fiber so as to form a concave V-shape; and
applying a reflecting medium to the distal end face.

26. The method according to claim 24, further comprising removing a portion of the cladding on a radially outer side of the multi-core optical fiber to form an exit surface though which light exits the multi-core optical fiber.

27. A method of using a multi-core optical probe to reduce light coupled back into an optical instrument caused by reflections from optical surfaces at a distal end of the probe, the method comprising:
attaching a multi-core probe to an optical instrument, wherein the multi-core probe comprises a plurality of cores embedded in a single cladding material;
wherein each of the plurality of cores embedded in the multi-core probe terminates at a corresponding angled reflector formed at a distal end of each core of the multi-core fiber probe,
wherein each of the plurality of angled reflectors deflects light propagating in each core at a deflection angle that is different from an axis of light propagation in the multi-core probe, and
wherein light propagating toward the distal end of each core of the multi-core probe is emitted, after reflection by a respective reflector, through an exit surface near the distal end of the multi-core probe, the exit surface being configured to substantially reduce a coupling of incident light on the exit surface back into the corresponding core without affecting light reflected or scattered back from an object outside the exit surface.

28. The method of claim 27, wherein the optical instrument comprises an interferometer.
